(19) United States
(12) Patent Application Publication
(10) Pub. No.: US 2025/0199245 A1
(43) Pub. Date: Jun. 19, 2025

(54) Multiple Fiber Block Transfer Switch

(71) Applicant: TELESCENT INC., Irvine, CA (US)

(72) Inventor: Anthony Stephen Kewitsch, Santa Monica, CA (US)

(73) Assignee: TELESCENT INC., Irvine, CA (US)

(21) Appl. No.: 18/845,792

(22) PCT Filed: Mar. 10, 2023
(86) PCT No.: PCT/US2023/014999

§ 371 Date: Sep. 10, 2024

Related U.S. Application Data
(60) Provisional application No. 63/319,235, filed on Mar. 11, 2022.

(51) Int. Cl. G02B 6/35; G02B 6/32

(52) U.S. Cl. CPC G02B 6/3508; G02B 6/32; G02B 6/356

(57) ABSTRACT

A fiber optic transfer switch to reconfigure multiple ganged ports in parallel, the fiber optic transfer switch comprising a pair of actuators; a first set of optical fibers which is translatable along longitudinal and transverse directions by the pair of actuators; and a second set of optical fibers and third set of optical fibers that are fixed, spaced apart and longitudinally opposing the first set of optical fibers, wherein the pair of actuators are constructed and adapted to alternately connect the first set of optical fibers to either (i) the second set of optical fibers or (ii) the third set of optical fibers.

### RELATED APPLICATION

This application is related to and claims priority/benefit of U.S. patent application 63/319,235, filed Mar. 11, 2022, the entire contents of which are hereby fully incorporated herein by reference for all purposes.

### COPYRIGHT STATEMENT

This patent document contains material subject to copyright protection. The copyright owner has no objection to the reproduction of this patent document or any related materials in the files of the United States Patent and Trademark Office, but otherwise reserves all copyrights whatsoever.

### FIELD OF THE INVENTION

Aspects of this invention relate to reconfiguring multiple ganged fiber optic ports in parallel.

### SUMMARY

Aspects of the present invention are specified in the claims and the below description Preferred embodiments are particularly specified in the dependent claims and the description of various embodiments.

One general aspect includes a fiber optic transfer switch to reconfigure multiple ganged ports in parallel. The fiber optic transfer switch also includes a pair of actuators. The switch also includes a first set of optical fibers which is translatable along longitudinal and transverse directions by the pair of actuators. The switch also includes multiple sets of optical fibers that are fixed, spaced apart, and longitudinally opposing the first set of optical fibers. The switch also includes where the pair of actuators are constructed and adapted to alternately connect the first set of optical fibers to either of the multiple sets of optical fibers.

A further aspect includes a fiber optic transfer switch to reconfigure multiple ganged ports in parallel. The fiber optic transfer switch also includes a pair of actuators. The switch also includes a first set of optical fibers which is translatable along longitudinal and transverse directions by the pair of actuators. The switch also includes a second set of optical fibers and a third set of optical fibers that are fixed, spaced apart, and longitudinally opposing the first set of optical fibers. The switch also includes where the pair of actuators are constructed and adapted to alternately connect the first set of optical fibers to either (i) the second set of optical fibers or (ii) the third set of optical fibers.

Implementations may include one or more of the following features, alone or in combination(s):
The fiber optic transfer switch may include: a first plurality of connectors, a second plurality of connectors, and a third plurality of connectors, where the first plurality of connectors terminate the first set of optical fibers, the second plurality of connectors terminate the second set of optical fibers and the third plurality of connectors terminate the third set of optical fibers, and where the pair of actuators are constructed and adapted to alternately connect the first set of optical fibers to either (i) the second set of optical fibers or (ii) the third set of optical fibers by alternately connecting the first plurality of connectors to either (a) the second plurality of connectors or (b) the third plurality of connectors.
The first plurality of connectors, the second plurality of connectors, and the third plurality of connectors may include expanded beam lensed connectors or non-contact MT ferrule connectors.
Each expanded-beam lensed connector may include an AR-coated lens array.
Opposing expanded beam lensed connectors or non-contact MT ferrule connectors create low optical insertion loss connections to either 2 or more fixed connector arrays.
Each connector terminates at least 12 fibers.
There are at least 4 connectors per set of optical fibers.
The actuators provide linear travel of about 25 mm and are electrically driven.
The fiber optic transfer switch may include one or more additional sets of optical fibers that are fixed, spaced apart, and longitudinally opposing the first set of optical fibers.
The pair of actuators are constructed and adapted to alternately connect the first set of optical fibers to either the second set of optical fibers, the third set of optical fibers or additional sets of optical fibers.

Another general aspect includes a method and may include: (a) providing a fiber optic transfer switch, (b) the first actuator disconnecting the first set of optical fibers from the second set of optical fibers, and then (c) the second actuator moving the first set of optical fibers from transverse alignment with the second set of optical fibers to transverse alignment with the third set of optical fibers, and then (d) connecting the first set of optical fibers the second set of optical fibers by moving the first actuator parallel to an axis of the optical fibers. Movement of the second actuator in (c) results in transverse movement perpendicular to a longitudinal axis of the optical fiber.

Another general aspect includes a system for execution of cross-connect reconfiguration batches. The system may include: a mass fiber transfer switch, wherein the system is configured to transfer sets of fibers pairs from a first automated cross-connect executing a current workflow to a second automated cross-connect pre-configured and staged to execute a second workflow once switched by the transfer switch.

Below is a list of device (or apparatus) embodiments. Those will be indicated with the letter “D.” Whenever such embodiments are referred to, this will be done by referring to “D” embodiments.
D1. A fiber optic transfer switch to reconfigure multiple ganged ports in parallel, the fiber optic transfer switch comprising:
a pair of actuators;
a first set of optical fibers which is translatable along longitudinal and transverse directions by the pair of actuators; and
a second set of optical fibers and a third set of optical fibers that are fixed, spaced apart, and longitudinally opposing the first set of optical fibers,
wherein the pair of actuators are constructed and adapted to alternately connect the first set of optical fibers to either (i) the second set of optical fibers or (ii) the third set of optical fibers.
D2. The fiber optic transfer switch of embodiment(s) D1, further comprising:
a first plurality of connectors, a second plurality of connectors, and a third plurality of connectors, wherein
the first plurality of connectors terminate the first set of optical fibers,
the second plurality of connectors terminate the second set of optical fibers, and
the third plurality of connectors terminate the third set of optical fibers, and
wherein the pair of actuators are constructed and adapted to alternately connect the first set of optical fibers to either (i) the second set of optical fibers or (ii) the third set of optical fibers by alternately connecting the first plurality of connectors to either (a) the second plurality of connectors or (b) the third plurality of connectors.
D3. The fiber optic transfer switch of embodiment(s) D2, wherein the first plurality of connectors, the second plurality of connectors, and the third plurality of connectors comprise expanded beam lensed connectors or non-contact MT ferrule connectors.
D4 The fiber optic transfer switch of any of embodiment(s) D2-D3, wherein each expanded beam lensed connector comprises an AR-coated lens array.
D5. The fiber optic transfer switch of any of embodiment(s) D2-D4, wherein opposing expanded beam lensed connectors or non-contact MT ferrule connectors create low optical insertion loss connections to either of 2 or more fixed connector arrays.
D6. The fiber optic transfer switch of any of embodiment(s) D2-D5, wherein the first plurality of connectors, the second plurality of connectors, and the third plurality of connectors comprise non-contact MT ferrule connectors.
D7. The fiber optic transfer switch of any of embodiment(s) D2-D6, wherein each connector terminates at least 12 fibers.
D8. The fiber optic transfer switch of any of embodiment(s) D2-D7, wherein there are at least 4 connectors per set of optical fibers.
D9. The fiber optic transfer switch of any of embodiment(s) D1-D8, wherein the actuators provide linear travel of about 25 mm and are electrically driven.
D10. The fiber optic transfer switch of any of embodiment(s) D1-D9, including one or more additional sets of optical fibers that are fixed, spaced apart, and longitudinally opposing the first set of optical fibers.
D11. The fiber optic transfer switch of any of embodiment(s) D1-D10, wherein the pair of actuators are constructed and adapted to alternately connect the first set of optical fibers to either the second set of optical fibers, the third set of optical fibers or additional sets of optical fibers.

Below is a list of method (or process) embodiments. Those will be indicated with the letter “P.” Whenever such embodiments are referred to, this will be done by referring to “P” embodiments.
P12. A method comprising:
(A) providing a fiber optic transfer switch according to any of embodiment(s) D1-D11;
(B) the first actuator disconnecting the first set of optical fibers from the second set of optical fibers; and then
(C) the second actuator moving the first set of optical fibers from transverse alignment with the second set of optical fibers to transverse alignment with the third set of optical fibers; and then
(D) connecting the first set of optical fibers and the second set of optical fibers by moving the first actuator parallel to an axis of the optical fibers.
P13. The method of embodiment(s) P12, wherein movement of the second actuator in (C) results in transverse movement perpendicular to a longitudinal axis of the optical fiber.
Below are system embodiments. Those will be indicated with the letter “S.” Whenever such embodiments are referred to, this will be done by referring to “S” embodiments.
S14. A system for execution of cross-connect reconfiguration batches, the system comprising a mass fiber transfer switch according to any of embodiment(s) D1-D11, the system being configured to transfer sets of fiber pairs from a first automated cross-connect executing a current workflow to a second automated cross-connect pre-configured and staged to execute a second workflow once switched by the transfer switch.

The above features and additional details of the invention are described further in the examples herein, which are intended to illustrate the invention further but not limit its scope in any way.

### BRIEF DESCRIPTION OF THE DRAWINGS

Objects, features, and characteristics of the present invention, as well as the methods of operation and functions of the related elements of structure and the combination of parts and economies of manufacture, will become more apparent upon consideration of the following description and the appended claims with reference to the accompanying drawings, all of which form a part of this specification.

FIGS. 1-4 illustrate side views of various states of a mass fiber transfer switch according to exemplary embodiments hereof;

FIG. 5 illustrates a top view of the mass fiber transfer switch shown in FIGS. 1-4 and comprised of arrays of non-contact, lensed connector arrays; and

FIG. 6 illustrates a block diagram of a system for execution of cross-connect reconfiguration batches, and comprised of mass fiber transfer switches according to exemplary embodiments hereof.

### DETAILED DESCRIPTION OF PRESENTLY PREFERRED EXEMPLARY EMBODIMENTS

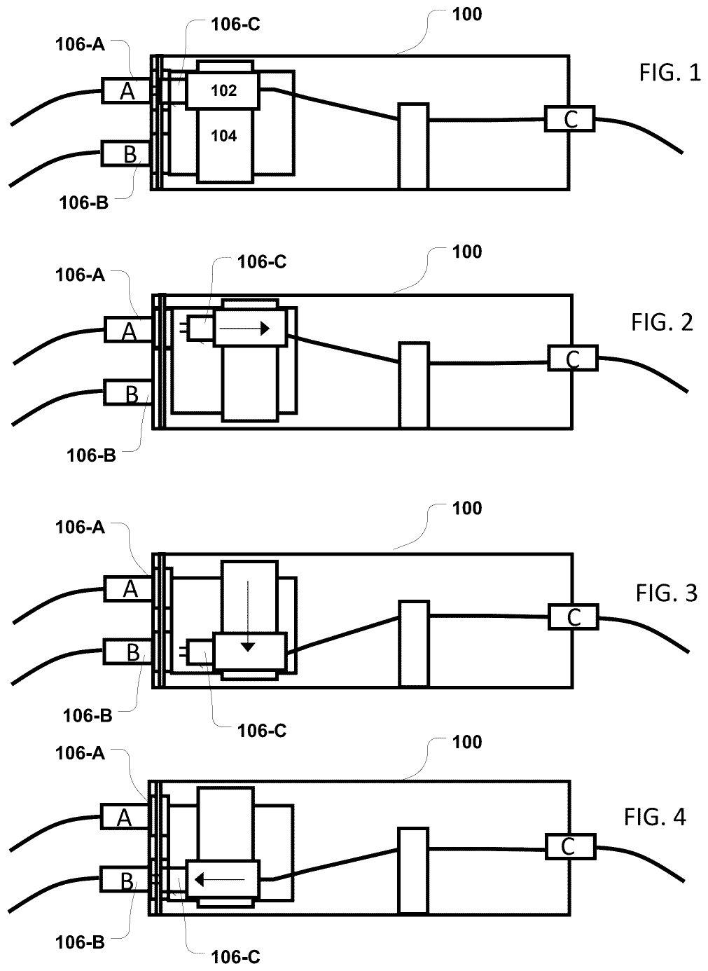

FIG. 1 is a side view of a mass fiber transfer switch 100, including a pair of actuators, a first actuator 102, and a second actuator 104. The actuators 102 and 104 may comprise a solenoid, dc motor, or stepper motor and generally require relatively low precision and electrical power consumption.

As shown in FIG. 1, three sets (A, B, and C) of fibers are connected to the switch 100. The sets of fibers are connected with corresponding optical fiber connectors 106-A, 106-B, and 106-C. In the example shown in the drawing (FIG. 1), the optical fiber connectors 106-C (for the first set C of fibers) are connected via the switch 100 to the optical fiber connectors 106-A (for the second set A of fibers).

Each set (A, B, and C) terminates multiple fiber paths. The typical number of connectors in a set is greater than or equal to 4, the typical number of fibers per connector is greater than or equal to 12, and the number of fiber paths is greater than 48.

Fiber interconnects are arrayed in a set, and each set is mounted within a block, including a lens array and precision alignment features.

To switch the connection from fiber sets A and C to fiber sets B and C, the switch first disconnects the optical fiber connectors 106-C (for set C) from the optical fiber connectors 106-A (for set A). Thus, as shown, e.g., in FIG. 2, the first actuator 102 disconnects the set of A fibers from the set of C fibers by unplugging or disconnecting the optical fiber connectors 106-C from the optical fiber connector 106-A.

The set of C fibers is then moved by the second actuator 104 from transverse alignment with the optical fiber connector of the set of A fibers to transverse alignment with the optical fiber connector for the set of B fibers. Thus, as shown, e.g., in FIG. 3, the second actuator 104 moves the optical fiber connectors 106-C (for the set of C fibers) from transverse alignment to the optical fiber connector 106-A (for the set of A fibers) to transverse alignment to the optical fiber connector 106-B (for the set of B fibers). The movement by the second actuator 104 results in transverse movement perpendicular to the optical fiber longitudinal axis.

The first actuator 102 then connects optical fiber connectors 106-B (for the set of B fibers) to optical fiber connector 106-C (for the set of C fibers) by moving the first actuator 102 parallel to the axis of the optical fiber and plugging in the connectors.

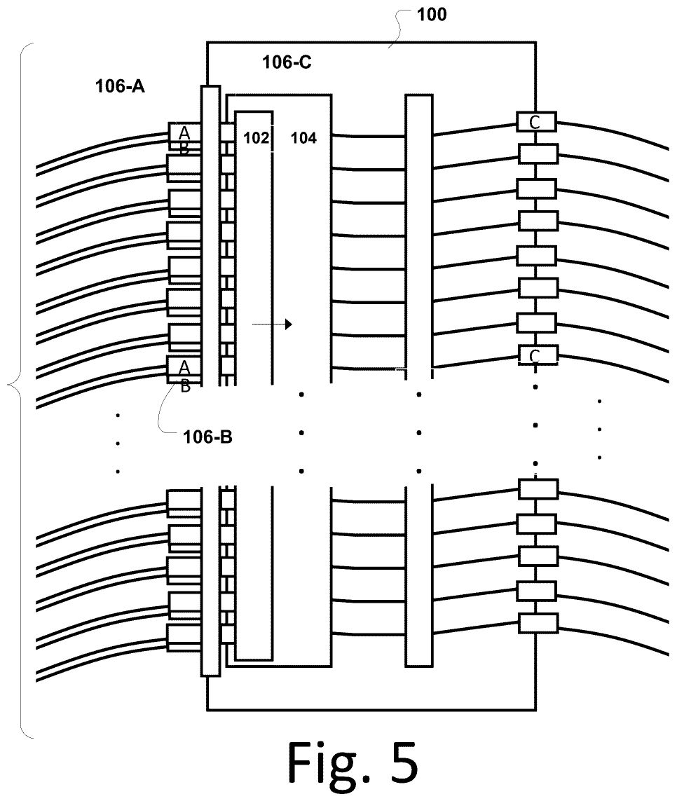

FIG. 5 illustrates a top view of the mass fiber transfer switch 100, as shown in FIGS. 1-4, comprised of non-contact, lensed connector arrays or non-contact MT ferrule connectors. For convenience, only one optical fiber connector is labeled in FIG. 5 for each set of fibers (A, B, C).

Although FIGS. 1-5 show only two alternate sets of fibers (A and B), more sets may be used by having one or more additional rows of fibers above the row of A fibers or below the row of B fibers. For example, a third row of D fibers may be positioned below the row of B fibers, and the actuator 102 may move further down (in the drawing) to connect the array C with the array D.

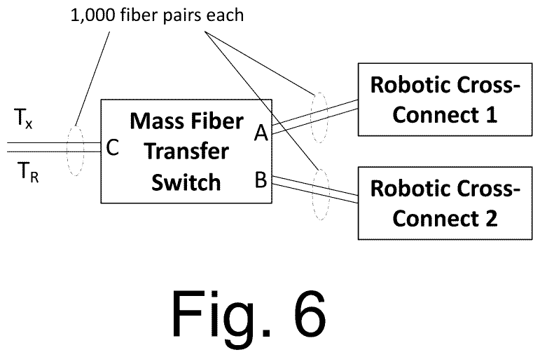

FIG. 6 illustrates a block diagram of a system for relatively fast execution of cross-connect reconfiguration batches, comprised of a mass fiber transfer switch that transfers large sets of fibers pairs from a first automated cross-connect executing a current workflow to a second automated cross-connect pre-configured and staged to execute a future (second) workflow once switched into the network by the transfer switch.

The optical fiber connectors (106-A, 106-B, 106-C) may be non-contact MT ferrule connectors, e.g., AirMT Connector connectors from SENKO Advance Co., Ltd. of Japan. Notably, non-contact connectors require a minimal force for insertion or disconnecting (e.g., less than 2 pounds of force per connector). When connected with non-contact connectors, a gap of 1 micron between the connector faces may be acceptable.

Alternatively, the connectors (106-A, 106-B, 106-C) may be expanded beam and lensed. The connectors (106-A, 106-B, 106-C) may comprise anti-reflective-coated (AR-coated) lenses. The lenses may be coated for low reflection at the wavelength(s) of interest (e.g., 1310 nm, 1550 nm). The connectors (106-A, 106-B, 106-C) may use single-mode or multi-mode fiber.

### EXAMPLES

In a first example, the fiber optic transfer switch (such as, e.g., 100 in FIGS. 1-5) comprises arrays of expanded beam, lensed connectors with 12, 16, or more fibers each. The two sets of lensed fiber arrays of output connectors are fixed and spaced apart from one another. A third set of input lensed fiber array connectors are mechanically aligned by a pair of actuators to either the first or second set of lensed fiber array connectors to establish connectivity. The actuator may be a solenoid, dc motor, or stepper motor and generally requires relatively low precision and electrical power consumption.

Opposing, axially aligned expanded beam lensed connectors provide low optical insertion loss connections between potentially large numbers of fibers. Expanded beam and lensed connectors are non-contact and utilize either single-mode or multi-mode fiber. Since the beams are expanded and spread across a relatively large surface of the lens, this approach is insensitive to dust or contamination of the fiber optic cable endface. This has significant advantages because it enables the mass transfer switch to be implemented without a fiber end face cleaning mechanism to maintain low insertion loss upon repeated connect/disconnect cycles.

In another example, each lensed fiber array connector is an expanded beam lensed connector comprised of an anti-reflective-coated (AR-coated) lens array to collimate the beams exiting the optical fiber array. The lenses are coated for low reflection at the wavelength(s) of interest (e.g., 1310 nm, 1550 nm). Typically these connectors are blind mating backplane connectors that can be ganged and have integral alignment features and mechanical float to facilitate low insertion force and accommodate misalignment. This enables a relatively low precision translation and actuation mechanism to be utilized to transfer from one block of ganged connectors to another block of ganged connectors. These blind mating optical backplane connectors enable large numbers of fibers to be connected and reconfigured as a set.

In a further example, each lensed connector has 16 fibers and is about 7 mm wide. Suitable connectors are supplied by companies including US Conec Ltd., Sumitomo and Senko. Sixty of these connectors may be arrayed along a row that is 435 mm long, corresponding to 960 fibers. Two rows can be stacked to form two sets of outputs. An opposing input row with the same number of connectors and fibers can then be connected to either of the two input rows. That is, the set C of 960 input fibers can be switched to either of two sets, A, B of 960 output fibers.

The output rows may be vertically spaced by, for example, 12 mm. The input connector block C, therefore, would move horizontally by about 12 mm to unplug or disconnect from connector block A, then down by 12 mm to move to the vertical level of block B, then move horizontally by 12 mm to plug into or connect connector block B. This movement is relatively small, so the array of fibers connected to block C will experience minimal slack change and no stress when moving between the two switch states. The term “unplug” refers to disconnection, even for non-contact connectors. Similarly, the term “plug into” is used to refer to connection, even for non-contact connectors.

### Discussion

Described are fiber optic switch devices to switch large groups of fiber as sets rather than individually. Reconfigurable sets of arrayed optical fiber connectors terminate multiple fiber paths, wherein multiple input fiber paths are switched together as a set between two or more sets of multiple output fiber paths. The number of sets is significantly smaller than (less than 10%) the number of fiber paths. The typical number of sets is two, the typical number of connectors in the set is greater than or equal to four, the typical number of fibers per connector is greater than or equal to twelve, and the number of fiber paths is more than forty-eight. Fiber interconnects are arrayed in the set, and each set is mounted within a block, including a lens array and precision alignment features. The input block is moved by an actuated, two-axis translation mechanism that plugs fiber interconnects as a set into one of a number (for example, 2, 3, or 4) of fixed output blocks.

A particular application of this mass fiber transfer switch is to connect each of its two sets of outputs to a robotic cross-connect(s). This enables large numbers of fiber interconnects to be transferred as a block from a first robotic cross-connect to a second robotic cross-connect. For example, a large number of physical fiber optic interconnects connect a large number of server, switch, and router ports at one end. The other end is connected to the transfer switch input set. The transfer switch has, for example, one input set and two output sets. The two transfer switch output sets are interconnected to the first and second robotic fiber cross-connects.

The pair of fiber optic cross-connect systems, each with 1,000 ports, for example, may be connected to the different outputs of the transfer switch so that a large number of cross-connect ports can be switched into the network within seconds. This approach enables fast transition from the current physical network topology to a new programmable, physical network topology optimized for the current computation workflows.

Each robot in the previously disclosed robotic patch panel or robotic cross-connect system (Kewitsch, U.S. Pat. No. 9,411,108) can reconfigure connections on a per fiber, or fiber pair, basis. If an individual fiber reconfiguration takes 50 seconds on average for the robot to complete, then 1,000 reconfigurations would take approximately 50,000 seconds. The entire contents of U.S. Pat. No. 9,411,108 are hereby fully incorporated herein by reference for all purposes.

In a typical compute cluster, the scheduled batch processing of hundreds or thousands of physical cross-connect instructions may need to be reconfigured relatively quickly and left static for weeks or more while the compute workload is executed. To minimize delays during the serial reconfiguration of large sets of fibers, it is advantageous to execute a batch of future connections on a second physical fiber cross-connect not yet switched into the network by the transfer switch. Once this new batch of connections on the second fiber cross-connect is completed and ready to be deployed to production, the mass fiber transfer switch moves a multiplicity (say, 1,000) of connections at one time from the previous configuration to the new configuration. All connections are changed in parallel, and the switching process then takes less than 20 seconds. Therefore, the mass fiber transfer switch, in combination with robotic patch panels and/or cross-connects, enables the fast execution of large batches of physical fiber optic interconnections. It also eliminates the need for thousands of 1×2 optical switches, which is space and price prohibitive. The resulting programmability of the physical network topology dramatically improves the performance and efficiency of data centers.

### Conclusion

Where a process is described herein, those of ordinary skill in the art will appreciate that the process may operate without any user intervention. In another embodiment, the process includes some human intervention (e.g., an act is performed by or with the assistance of a human).

As used herein, including in the claims, the phrase “at least some” means “one or more” and includes the case of only one. Thus, e.g., the phrase “at least some ABCs” means “one or more ABCs” and includes the case of only one ABC.

As used herein, including in the claims, the term “at least one” should be understood as meaning “one or more,” and therefore includes both embodiments that include one or multiple components. Furthermore, dependent claims that refer to independent claims that describe features with “at least one” have the same meaning, both when the feature is referred to as “the” and “the at least one.”

As used herein, including in the claims, the phrase “using” means “using at least” and is not exclusive. Thus, e.g., the phrase “using x” means “using at least x.” Unless specifically stated by the use of the word “only,” the phrase “using x” does not mean “using only x.”

As used herein, including in the claims, the phrase “based on” means “based in part on” or “based, at least in part, on” and is not exclusive. Thus, e.g., the phrase “based on factor x” means “based in part on factor x” or “based, at least in part, on factor x.” Unless specifically stated by the use of the word “only,” the phrase “based on x” does not mean “based only on x.”

In general, as used herein, including in the claims, unless the word “only” is specifically used in a phrase, it should not be read into that phrase.

As used herein, including in the claims, the phrase “distinct” means “at least partially distinct.” Unless specifically stated, distinct does not mean fully distinct. Thus, e.g., the phrase, “x is distinct from Y” means that “x is at least partially distinct from Y” and does not mean that “x is fully distinct from Y.” Thus, as used herein, including in the claims, the phrase “x is distinct from Y” means that x differs from Y in at least some way.

It should be appreciated that the words “first,” “second,” and so on in the description and claims are used to distinguish or identify and not to show a serial or numerical limitation. Similarly, letter labels (e.g., “(A),” “(B),” “(C),” and so on, or “(a),” “(b),” and so on) and/or numbers (e.g., “(i),” “(ii),” and so on) are used to assist in readability and to help distinguish and/or identify and are not intended to be otherwise limiting or to impose or imply any serial or numerical limitations or orderings. Similarly, words such as “particular,” “specific,” “certain,” and “given” in the description and claims, if used, are to distinguish or identify and are not intended to be otherwise limiting.

As used herein, including in the claims, the terms “multiple” and “plurality” mean “two or more” and include the case of “two.” Thus, e.g., the phrase “multiple ABCs” means “two or more ABCs” and includes “two ABCs.” Similarly, e.g., the phrase “multiple PQRs,” means “two or more PQRs,” and includes “two PQRs.”

The present invention also covers the exact terms, features, values, and ranges, etc., in case these terms, features, values, and ranges, etc. are used in conjunction with terms such as about, around, generally, substantially, essentially, at least, etc. (for example, “about 3” or “approximately 3” shall also cover exactly 3 or “substantially constant” shall also cover exactly constant).

As used herein, including in the claims, singular forms of terms are to be construed as also including the plural form and vice versa unless the context indicates otherwise. Thus, it should be noted that as used herein, the singular forms “a,” “an,” and “the” include plural references unless the context clearly and expressly dictates otherwise.

Throughout the description and claims, the terms “comprise,” “including,” “having,” and “contain” and their variations should be understood as meaning “including but not limited to” and are not intended to exclude other components unless specifically so stated.

It will be appreciated that variations to the embodiments of the invention can be made while still falling within the scope of the invention. Alternative features serving the same, equivalent, or similar purpose can replace features disclosed in the specification unless stated otherwise. Thus, unless stated otherwise, each feature disclosed represents one example of a generic series of equivalent or similar features.

Use of exemplary phrases or terms, such as “for instance,” “such as,” “for example” (“e.g.,”) and the like, is merely intended to illustrate the invention better and does not indicate a limitation on the scope of the invention unless specifically so claimed. The abbreviation, “i.e.,” means “that is.”

While a particular feature of the invention may have been disclosed with respect to only one of several implementations, such feature may be combined with one or more other features of the other implementations as may be desired and advantageous for any given or particular application. Furthermore, to the extent that the terms “includes,” “including,” and variants thereof are used in either the detailed description or the claims, these terms are intended to be inclusive in a manner similar to the term “comprising.”

While the invention has been described in connection with what is presently considered to be the most practical and preferred embodiments, it is to be understood that the invention is not to be limited to the disclosed embodiment but, on the contrary, is intended to cover various modifications and equivalent arrangements included within the spirit and scope of the appended claims.

1. A fiber optic transfer switch to reconfigure multiple ganged ports in parallel, the fiber optic transfer switch comprising:
a pair of actuators;
a first set of optical fibers which is translatable along longitudinal and transverse directions by the pair of actuators; and
a second set of optical fibers and a third set of optical fibers that are fixed, spaced apart, and longitudinally opposing the first set of optical fibers,
wherein the pair of actuators are constructed and adapted to alternately connect the first set of optical fibers to either (i) the second set of optical fibers or (ii) the third set of optical fibers.

2. The fiber optic transfer switch of claim 1, further comprising:
a first plurality of connectors, a second plurality of connectors, and a third plurality of connectors, wherein
the first plurality of connectors terminate the first set of optical fibers,
the second plurality of connectors terminate the second set of optical fibers, and
the third plurality of connectors terminate the third set of optical fibers, and
wherein the pair of actuators are constructed and adapted to alternately connect the first set of optical fibers to either (i) the second set of optical fibers or (ii) the third set of optical fibers by alternately connecting the first plurality of connectors to either (a) the second plurality of connectors or (b) the third plurality of connectors.

3. The fiber optic transfer switch of claim 2, wherein the first plurality of connectors, the second plurality of connectors, and the third plurality of connectors comprise expanded beam lensed connectors.

4. The fiber optic transfer switch of claim 3, wherein each expanded beam lensed connector comprises an AR-coated lens array.

5. The fiber optic transfer switch of claim 3, wherein opposing expanded beam lensed connectors create low optical insertion loss connections to either of 2 or more fixed connector arrays.

6. The fiber optic transfer switch of claim 2, wherein the first plurality of connectors, the second plurality of connectors, and the third plurality of connectors comprise non-contact MT ferrule connectors.

7. The fiber optic transfer switch of claim 2, wherein each connector terminates at least 12 fibers.

8. The fiber optic transfer switch of claim 2, wherein there are at least 4 connectors per set of optical fibers.

9. The fiber optic transfer switch of claim 1, wherein the actuators provide linear travel of about 25 mm and are electrically driven.

10. The fiber optic transfer switch of claim 1, including one or more additional sets of optical fibers that are fixed, spaced apart, and longitudinally opposing the first set of optical fibers.

11. The fiber optic transfer switch of claim 10, wherein the pair of actuators are constructed and adapted to alternately connect the first set of optical fibers to either the second set of optical fibers, the third set of optical fibers or additional sets of optical fibers.

12. A method comprising:
(A) providing a fiber optic transfer switch comprising:
a pair of actuators, being a first actuator and a second actuator;
a first set of optical fibers which is translatable along longitudinal and transverse directions by the pair of actuators; and
a second set of optical fibers and a third set of optical fibers that are fixed, spaced apart, and longitudinally opposing the first set of optical fibers,
wherein the pair of actuators are constructed and adapted to alternately connect the first set of optical fibers to either (I) the second set of optical fibers or (ii) the third set of optical fibers;
(B) the first actuator disconnecting the first set of optical fibers from the second set of optical fibers; and then
(C) the second actuator moving the first set of optical fibers from transverse alignment with the second set of optical fibers to transverse alignment with the third set of optical fibers; and then
(D) connecting the first set of optical fibers and the second set of optical fibers by moving the first actuator parallel to an axis of the optical fibers.

13. The method of claim 12, wherein movement of the second actuator in (C) results in transverse movement perpendicular to a longitudinal axis of the optical fiber.

14. A system for execution of cross-connect reconfiguration batches, the system comprising:
a mass fiber transfer switch comprising:
a pair of actuators;
a first set of optical fibers which is translatable along longitudinal and transverse directions by the pair of actuators; and
a second set of optical fibers and a third set of optical fibers that are fixed, spaced apart, and longitudinally opposing the first set of optical fibers,
wherein the pair of actuators are constructed and adapted to alternately connect the first set of optical fibers to either (i) the second set of optical fibers or (ii) the third set of optical fibers, wherein
the system is configured to transfer sets of fiber pairs from a first automated cross-connect executing a current workflow to a second automated cross-connect pre-configured and staged to execute a second workflow once switched by the mass fiber transfer switch.

15. The system of claim 14, wherein the mass fiber transfer switch further comprises:
a first plurality of connectors, a second plurality of connectors, and a third plurality of connectors, wherein
the first plurality of connectors terminate the first set of optical fibers,
the second plurality of connectors terminate the second set of optical fibers, and
the third plurality of connectors terminate the third set of optical fibers, and
wherein the pair of actuators are constructed and adapted to alternately connect the first set of optical fibers to either (i) the second set of optical fibers or (ii) the third set of optical fibers by alternately connecting the first plurality of connectors to either (a) the second plurality of connectors or (b) the third plurality of connectors.

16. The system of claim 15, wherein the first plurality of connectors, the second plurality of connectors, and the third plurality of connectors comprise expanded beam lensed connectors.

17. The system of claim 16, wherein each expanded beam lensed connector comprises an AR-coated lens array.

18. The system of claim 15, wherein opposing expanded beam lensed connectors create low optical insertion loss connections to either of 2 or more fixed connector arrays.

19. The system of claim 15, wherein the first plurality of connectors, the second plurality of connectors, and the third plurality of connectors comprise non-contact MT ferrule connectors.

20. The fiber optic transfer switch of claim 15, wherein each connector terminates at least 12 fibers.
